(19) United States
(12) Patent Application Publication
(10) Pub. No.: US 2021/0256244 A1
(43) Pub. Date: Aug. 19, 2021

(54) METHOD FOR AUTHENTICATION OR IDENTIFICATION OF AN INDIVIDUAL

(71) Applicant: IDEMIA IDENTITY & SECURITY FRANCE, Courbevoie (FR)

(72) Inventors: Grégoire BEZOT, Courbevoie (FR); Jean-François SIWEK, Courbevoie (FR); Marine PESCHAUX, Courbevoie (FR)

(21) Appl. No.: 17/168,718

(22) Filed: Feb. 5, 2021

(30) Foreign Application Priority Data
Feb. 14, 2020 (FR) 2001466

(51) Int. Cl. G06K 9/00; G06K 9/20

(52) U.S. Cl. CPC G06K 9/00201; G06K 9/2054; G06K 9/2018; G06K 9/00604; G06K 9/00255

(57) ABSTRACT

A method for authentication or identification of an individual, that comprises the implementation by data processing means of a terminal, of the following steps: (a) Obtaining a radiation image and a depth map on each of which appears a biometric feature of said individual; (b) Identification in said depth map of a first region of interest likely to contain said biometric feature as all of the pixels of said depth map associated with a depth value which is within a predetermined range; (c) Selection in said radiation image of a second region of interest corresponding to said first region of interest identified in the depth map; (d) Detection of said biometric feature of the individual in said second region of interest selected of said radiation image; and, (e) Authentication or identification of said individual on the basis of the biometric feature detected.

### CROSS-REFERENCE TO RELATED APPLICATIONS

This application claims priority pursuant to 35 U.S.C. 119(a) of French Patent Application No. 2001466, filed Feb. 14, 2020, which application is incorporated herein by reference in its entirety.

### FIELD OF THE INVENTION

The present invention relates to the field of biometric authentication and identification, in particular by facial or iris recognition.

### BACKGROUND OF THE INVENTION

Biometric access control terminals are known, in particular based on optical recognition: an authorized user positions a biometric feature (his or her face, iris, etc.), in front of the terminal, the latter is recognized and a gate for example is unlocked.

Generally, this type of terminal is equipped with one or more 2D or 3D camera type sensors, with a “wide visual range” which enables the product to have good ergonomics (the user does not need to position himself or herself precisely in a specific spot), and light sources such as LEDs, emitting visible or infrared (IR) light, and/or laser diodes. Indeed, the cameras can only function correctly if the illumination of the subject is correct.

A first difficulty, even prior to the implementation of the biometric processing, is the detection of the “correct subject”, i.e., the face of the user who actually requires access (it is common for several people to be present in the range of the cameras), and the correct exposure thereof.

The problem is that these two tasks are generally inextricably linked: it is known to “adjust” the camera and the light sources in order to adapt the exposure in relation to a region of interest detected in the field of vision (more precisely, the exposure of any image is modified based on the brightness observed in this region, in other words, the brightness of the region is “normalized”, possibly to the detriment of other regions of the image which could, if applicable, become over- or under-exposed), but good exposure is already needed to perform the correct detection of said region of interest. And yet, it is observed that the variety of installations, light environments, distances of use, further complicate these tasks.

It is possible quite simply to reuse the previous camera settings, but often from one moment to another of the day the lighting conditions have completely changed.

It is otherwise possible to reuse a previously considered region of interest and automatically adjust the exposure in relation to this region of interest but again the individual may have a very different position and the previous image may have been poorly exposed, most particularly when the field of view is very wide, considerably larger than the region of interest (face).

Consequently, the use of high-dynamic-range (HDR) imaging techniques has been proposed, making it possible to store numerous light intensity levels in an image (several different exposure values), and thus to test the whole dynamic range of the illumination possible. However, manipulating such HDR images is cumbersome and slower, with the result that the user experience is diminished.

Alternatively, it has been proposed to select “the closest” face from a plurality as a potential region of interest based on the pixel size and then to adjust the exposure in relation to this face. This technique is satisfactory, but it has been noted that it could then be possible to deceive the terminal by placing in the background a noticeboard or a poster representing a large-scale face, which will then be considered as the region of interest to the detriment of the actual faces of individuals in front of the terminal (the latter appearing “further away”). In addition, if the exposure is adjusted to optimize a face which is very far away, then a face which may then arrive considerably closer to the camera will not even be seen, because it would then be saturated. It may not then be possible to optimize the dynamic range on this new face.

Consequently, it would be desirable to have a new simple, reliable and effective solution to improve the performance of biometric authentication and identification algorithms.

### SUMMARY OF THE INVENTION

According to a first aspect, the present invention relates to a method for authentication or identification of an individual, characterized in that it comprises the implementation by data processing means of a terminal of the following steps:

(a) Obtaining a radiation image and a depth map on each of which appears a biometric feature of said individual;
(b) Identification in said depth map of a first region of interest likely to contain said biometric feature;
(c) Selection in said radiation image of a second region of interest corresponding to said first region of interest identified in the depth map;
(d) Detection of said biometric feature of the individual in said second region of interest selected of said radiation image;
(e) Authentication or identification of said individual on the basis of the biometric feature detected

According to other advantageous and non limiting characteristics:

The step (a) comprises the acquisition of said radiation image from data acquired by first optical acquisition means of the terminal and/or the acquisition of said depth map from data acquired by second optical acquisition means of the terminal.
Said first region of interest is identified in step (b) as all of the pixels of said depth map associated with a depth value which is within a predetermined range.
Said step (c) further comprises the removal from said radiation image of stationary objects.
Said step (d) further comprises the adaptation of the exposure of the radiation image in relation to the second region of interest selected.

The radiation image and the depth map have substantially the same viewpoint. Said biometric feature of the individual is selected from a face and an iris of the individual.

Step (e) comprises the comparison of the biometric feature detected with reference biometric data stored on data storage means.
Step (e) comprises the implementation of an access control based on the result of said biometric identification or authentication.
The radiation image is a visible image or an infrared image.

According to a second aspect, the present invention relates to a terminal comprising data processing means configured to implement:
obtaining a radiation image and a depth map on each of which appears a biometric feature of said individual;
the identification in said depth map of a first region of interest likely to contain said biometric feature;
the selection in said radiation image of a second region of interest corresponding to said first region of interest identified in the depth map;
the detection of said biometric feature of the individual in said second region of interest selected of said radiation image;
the authentication or identification of said individual on the basis of the biometric feature detected.

According to other advantageous and non limiting characteristics, the terminal comprises first optical acquisition means 13a for the acquisition of said radiation image and/or second optical acquisition means 13b for the acquisition of said depth map.

According to a third and a fourth aspect, the invention proposes a computer program product comprising code instructions for the execution of a method according to the first aspect for authentication or identification of an individual; and a storage means readable by computer equipment on which a computer program product comprises code instructions for the execution of a method according to the first aspect for authentication or identification of an individual.

### BRIEF DESCRIPTION OF THE DRAWINGS

Other characteristics and advantages of the present invention will appear upon reading the following description of a preferred embodiment. This description will be given with reference to the attached drawings in which:

FIG. 1 represents in general a terminal for the implementation of the method for authentication or identification of an individual according to the invention;

FIG. 2 schematically represents the steps of an embodiment of the method for authentication or identification of an individual according to the invention;

FIG. 3a represents an example of a radiation image used in the method according to the invention;

FIG. 3b represents an example of a depth map used in the method according to the invention;

FIG. 3c represents an example of a first region of interest used in the method according to the invention; and,

FIG. 3d represents an example of a second region of interest used in the method according to the invention.

### DETAILED DESCRIPTION OF THE INVENTION

### Architecture

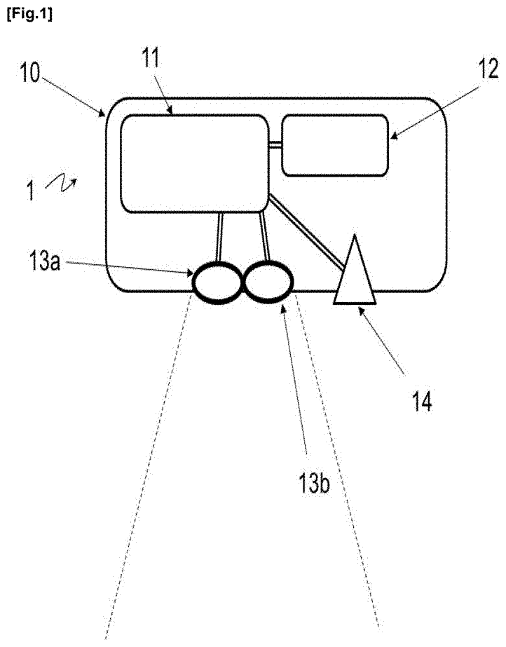

Referring to [FIG. 1], a terminal 1 is proposed for the implementation of a method for authentication or identification of an individual, i.e. to determine or verify the identity of the individual presenting himself or herself in front of the terminal 1, in order to, where applicable, authorize access to this individual. As will be seen, this is typically facial biometrics (facial or iris recognition), in which the user must bring his or her face closer, but also print biometrics (finger or palm print) at a distance in which the user brings his or her hand close.

The terminal 1 is typically equipment held and controlled by an entity with whom the authentication/identification must be performed, for example a government body, customs, a company, etc. It should be understood that it may otherwise be personal equipment belonging to an individual, such as for example a mobile phone or “smartphone”, an electronic tablet, a personal computer, etc.

In the remainder of the present description, the example of an access control terminal for a building will be used (for example a terminal making it possible to open a door—generally this is a terminal mounted on a wall next to this door), but it should be noted that this present method remains applicable in many situations, for example to authenticate an individual wishing to board an airplane, access personal data or an application, perform a transaction, etc.

The terminal 1 comprises data processing means 11, typically of processor type, managing the operation of the terminal 1, and controlling its various components, most commonly in a unit 10 protecting its various components.

Preferably, the terminal 1 comprises first optical acquisition means 13a and/or second optical acquisition means 13b, typically arranged in order to observe a scene generally located “in front” of the terminal 1 and to acquire data, in particular images of a biometric feature such as the face or the iris of an individual. For example, in the case of a wall-mounted access control terminal, the optical acquisition means 13a, 13b are positioned at head height in order to be able to see the face of the individuals approaching it. It is noted that there may well be other optical acquisition means 13a, 13b which could observe another scene (and which are not involved in the desired biometric operation): smartphone type mobile terminals generally have both front and rear cameras. The remainder of the present description will focus on the scene “viewed” by the optical acquisition means 13, i.e. that “facing” the optical acquisition means 13, which therefore can be seen and in which performance of the biometric identification or authentication is desired.

The first optical acquisition means 13a and the second optical acquisition means 13b are different in nature, since, as will be seen, the present method uses a radiation image and a depth map on each of which appears a biometric feature of said individual.

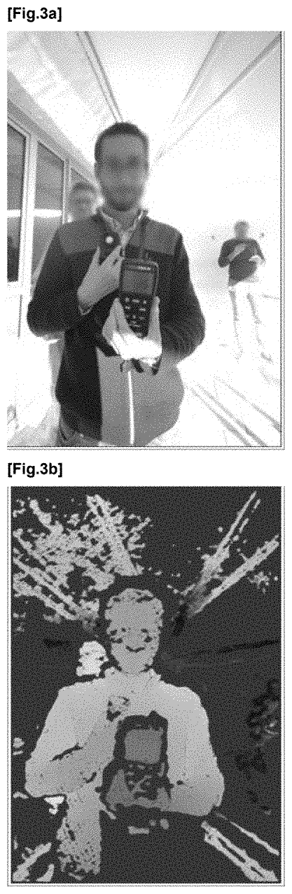

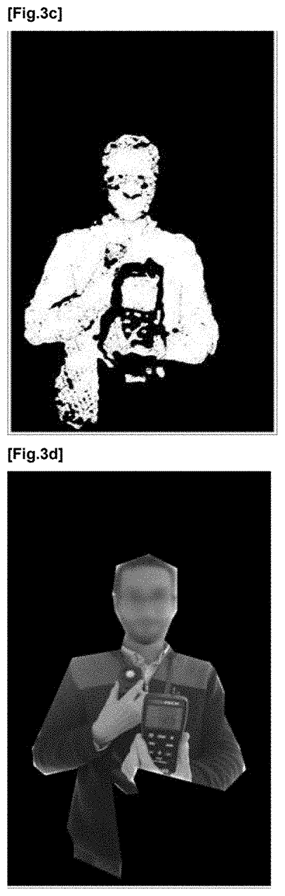

More precisely, the first optical acquisition means 13a are sensors enabling the acquisition of a “radiation” image, i.e., a conventional image in which each pixel reflects the actual appearance of the scene observed, i.e. where each pixel has a value corresponding to the quantity of electromagnetic radiation received in part of the given electromagnetic spectrum. Most often, said radiation image is, as can be seen in [FIG. 3a], a visible image (generally a color image—RGB type—for which the value of a pixel defines its color, but also a gray-scale or even black and white image—for which the value of a pixel defines its brightness), i.e. the image as can be seen by the human eye (the electromagnetic spectrum concerned is the visible spectrum—band from 380 to 780 nm), but this may alternatively be an IR image (infrared—for which the electromagnetic spectrum concerned is that of wavelengths beyond 700 nm, in particular of the order of 700 to 2000 nm for the “near infrared” (NIR) band), or even images related to other parts of the spectrum.

It is noted that the present method may use several radiation images in parallel, in particular from various parts of the electromagnetic spectrum, if applicable respectively acquired via several different first optical acquisition means 13a. For example, it is possible to use a visible image and an IR image.

The second optical acquisition means 13b are sensors themselves enabling the acquisition of a “depth map”, i.e., an image of which the pixel value is the distance according to the optical axis between the optical center of the sensor and the point observed. Referring to [FIG. 3b], a depth map is occasionally represented (in order to be visually understandable) as a gray-scale or color image of which the luminance of each point is based on the distance value (the closer a point is, the lighter it is) but it should be understood that this is an artificial image as opposed to the radiation images defined above.

It is understood that numerous sensor technologies making it possible to obtain a depth image are known (“time-of-flight”, stereovision, sonar, structured light, etc.), and that in most cases, the depth map is in practice reconstructed by the processing means 11 from raw data supplied by the second optical acquisition means 13b and which must be processed (it is reiterated that a depth map is an artificial object which a sensor cannot easily obtain via a direct measurement). Thus, for convenience, the expression “acquisition of the depth map via the second optical acquisition means 13b” will continue to be used even though the person skilled in the art will understand that this acquisition generally involves the data processing means 11.

It is noted that the first and second optical acquisition means 13a, 13b are not necessarily two independent sensors and may be more or less taken together.

For example, what is commonly called a “3D camera” is often a set of two juxtaposed 2D cameras (forming a stereoscopic pair). One of these two cameras may constitute the first optical acquisition means 13a, and the two together may constitute the second optical acquisition means 13b.

Are even known convolutional neural networks (CNN) able to generate the depth map from a visible or IR image, such that it is possible to only have for instance the first means 13a: they allow to directly acquire the radiation image, and indirectly the depth map (by processing the radiation image using the CNN).

Moreover, the biometric feature to be acquired from said individual (his or her face, iris, etc.) must appear at least in part on both the radiation image and on the depth map, such that they must be able to observe more or less the same scene in the same way, i.e., the radiation image and the depth map should sensible coincide. Preferably, the first and second optical acquisition means 13a, 13b have substantially the same viewpoint, i.e., they are arranged closely, at most a few tens of centimeters apart, advantageously a few centimeters (in the example of two cameras forming a stereoscopic pair, their distance is conventionally of the order of 7 cm), with optical axes which are parallel or oriented one in relation to the other at most by a few degrees, et with sensibly the same optical settings (depth of field, zoom, etc.). This is the case in the example of FIGS. 3a and 3b, where it can be seen that the viewpoints and the orientations match.

However, it is still possible to have more widely spaced sensors, as long as recalibration algorithms are known (knowing their relative positions and orientations). In any case, possible parts of the scene that would be visible at the same time in both the radiation image and the depth map would be ignored.

It is to be noted the first and/or the second optical acquisition means 13a, 13b are preferably fixed, with constant optical settings (no variable zoom for instance), so as to be sure that the continue observing the scene in the same way.

Of course, the first and second optical acquisition means 13a, 13b are synchronized so as to acquire data substantially simultaneously. The radiation image and the depth map must represent the individual substantially at the same moment (i.e. within a few milliseconds or a few dozen milliseconds), even though it is still entirely possible to operate these means 13a, 13b in an entirely independent manner (or even further away).

Furthermore, the terminal 1 may advantageously comprise lighting means 14 adapted to light said scene opposite said optical acquisition means 13a, 13b (i.e., they will be able to light the subjects observable by the optical acquisition means 13a, 13b, they are generally positioned near the latter in order to “look” in the same direction). Thus, it is understood that the light emitted by the lighting means 14 is received and re-emitted by the subject towards the terminal 1, which allows the optical acquisition means 13a, 13b to acquire data of adequate quality and to increase the reliability of any subsequent biometric processing. Indeed, a face in the semi-darkness will for example be more difficult to recognize. Also, it has been observed that “spoofing” techniques in which an individual attempts to fraudulently deceive an access control terminal by means of accessories such as a mask or a prosthesis are easier to identify under adequate lighting.

Finally, the data processing means 11 are often connected to data storage means 12 storing a reference biometric database, preferentially of images of faces or of irises, so as to make it possible to compare a biometric feature of the individual appearing on the radiation image with the reference biometric data. The means 12 may be those of a remote server to which the terminal 1 is connected, but they are advantageously local means 12, i.e., included in the terminal 1 (in other words the terminal 1 comprises the storage means 12), so as to avoid any transfer of biometric data to the network and to limit risks of interception or of fraud.

### Method

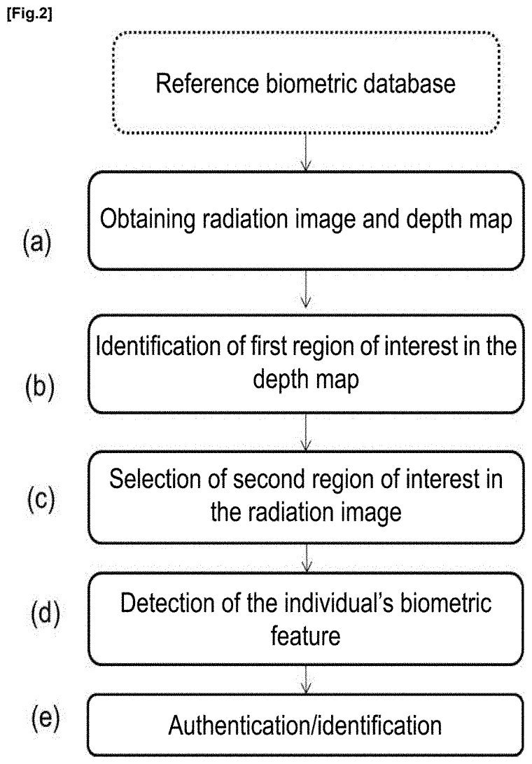

Referring to [FIG. 2], the present method, implemented by the data processing means 11 of the terminal 1, starts with a step (a) for obtaining at least one radiation image and a depth map on each of which appears a biometric feature of said individual. As explained, if the terminal 1 directly comprises the first optical acquisition means 13a and/or the second optical acquisition means 13b, this step may comprise the acquisition of data by these means 13a, 13b and the respective obtaining of the radiation image from data acquired by the first optical acquisition means and/or from the depth map by the second optical acquisition means 13b.

However, the method is not limited to this embodiment, and the radiation image and the depth map may be obtained externally and simply transmitted to the data processing means 11 for analysis.

In a step (b), a first region of interest likely to contain said biometric feature is identified in said depth map. Region of interest is understood to mean one (or several, the region of interest is not necessarily a continuous unit) spatial zone which is semantically more interesting and on which it is considered that the desired biometric feature will be found (and not outside this region of interest).

Thus, whereas it was known to attempt to identify a region of interest directly in the radiation image, it is considerably easier to do it in the depth map:
the latter is only slightly affected by the exposure (the depth map does not comprise any information dependent on the brightness);
is very selective as it makes it possible to easily separate the distinct objects and in particular those in the foreground in comparison to those in the background.

For this, said first region of interest is advantageously identified in step (b) as all of the pixels of said depth map associated with a depth value which is within a predetermined range, advantageously the nearest pixels. This is a simple thresholding of the depth map, making it possible to filter the objects at the desired distance from terminal 1, optionally coupled with an algorithm making it possible to aggregate pixels into objects or blobs (to avoid having several distinct regions of interest corresponding for example to several faces which may or may not be at the same distance). Thus, a large-scale face on a poster will be excluded as it is too far, even if the size of the face on the poster had been selected in an appropriate manner.

Preferably, the range [0; 2 m] or even [0; 1 m] will be used as an example in the case of a wall-mounted terminal 1, but depending on the case, it may be possible to vary this range (for example in the case of a smartphone type personal terminal, this could be limited to 50 cm).

Alternatively or additionally, it is possible to implement a detection/classification algorithm (for example via a convolutional neural network, CNN) on the depth map in order to identify said first region of interest likely to contain said biometric feature, for example the closest human figure.

At the end of the step (b), it is possible to obtain a mask defining the first zone of interest. As such, the example of [FIG. 3c] corresponds to the mask representing the first region of interest obtained from the map in FIG. 3b by selecting the pixels associated with a distance of less than 1 m: the white pixels are those identified as forming part of the region of interest and the black pixels are those excluded (as they do not form part of it), hence the term “mask”. Note that it is possible to use other representations of the first region of interest, such as for example the list of pixels selected, or the coordinates of an outline of the region of interest.

Then, in a step (c), this time in the radiation image a second region of interest is selected corresponding to said first region of interest identified in the depth map. If there are several radiation images (for example a visible image and an IR image), this selection (and the following steps) may be used on each radiation image. It is to be understood that this selection is performed in the previously acquired radiation image, on the basis of image pixels. It does not imply, for instance, acquiring a new radiation image that would focus on the first region of interest, that would be complex and require mobile first acquisition means 13a.

In other words, the first region of interest obtained on the depth map is “projected” into the radiation image. If the radiation image and the depth map have substantially the same viewpoint and the same direction, it is possible to simply apply the mask obtained to the radiation image, i.e., the radiation image is filtered: the pixels in the radiation image belonging to the first region of interest are retained, the information in the others is destroyed (value set to zero—black pixel).

Alternatively, the coordinates of the pixels in the first region of interest are transposed on the radiation image taking into account the positions and orientations of the cameras, in a manner known by a person skilled in the art. For example, this may be performed by learning the features of the camera systems automatically (parameters intrinsic to the camera such as the focal length and distortion, and extrinsic parameters such as the position and orientation). This learning, performed once for all, then makes it possible to perform the “projection” by calculations during the image processing.

FIG. 3d thus represents the second region of interest obtained by applying the mask of FIG. 3c to the radiation image of FIG. 3a. It is clear that the unnecessary background is removed and that only the individual remains in the foreground.

In addition, the step (c) may advantageously further comprise the removal from said radiation image of stationary objects. More precisely, the second region of interest is limited to moving objects. Thus, a pixel in the radiation image is selected as forming part of the second region of interest if it corresponds to a pixel in the first region of interest AND if it forms part of a moving object. The idea is that there may be objects nearby which remain from unnecessary scenery, for example plants or wardrobes.

For this, numerous techniques are known by a person skilled in the art, and it may be possible for example to obtain two successive radiation images and subtract them, or even to use tracking algorithms to estimate speeds of objects or of pixels.

Preferably, this removal may be performed directly in the depth map in step (b). Indeed, motion detection is easy in the depth map as any movement of an object in the field is immediately translated into a change in distance with the camera, and therefore a change in local value in the depth map. And, by directly limiting the first region of interest to the moving objects in step (b), the second region of interest will be so automatically in step (c) as long as the second region of interest corresponds to the first region of interest.

It is understood that step (c) is a step for “extracting” useful information from the radiation image. Thus, at the end of step (c) there is therefore a “simplified” radiation image limited to the second region of interest selected.

In a step (d), said biometric feature of the individual is detected in said second region of interest selected of said radiation image. It will be possible to choose any detection technique known by a person skilled in the art, and in particular to use a convolutional neural network, CNN, for detection/classification. It is to be noted that for convenience said detection may be performed on the whole radiation image, and then what is detected outside the second region of interest is discarded.

In a conventional manner, step (d) preferentially comprises the prior adaptation of the exposure of the radiation image (or just of the simplified radiation image) in relation to the second region of interest selected. For this, as explained, the exposure of the entire image is normalized in relation to that of the zone considered: thus, there is no doubt that the pixels of the second region of interest are exposed in an optimal way, if applicable to the detriment of the rest of the radiation image, but this is of no importance as the information in this rest of the radiation image has been rejected.

Thus:
the time and complexity of the detection algorithm are reduced as only a fraction of the radiation image needs to be analyzed;
the risks of false positives on the part not selected are eliminated (common if CNN is used for detection);
there is no doubt that the detection conditions are optimal in the second region of interest and therefore that the detection performance thereof is optimal.

It is noted that step (d) may further comprise a new adaptation of the exposure of the radiation image on an even more precise zone after the detection, i.e. in relation to the biometric feature detected (generally its detection “box” containing it) in the second region of interest, so as to optimize the exposure more accurately.

Finally, in a step (e), the authentication or identification per se of said individual is implemented on the basis of the biometric feature detected.

More precisely, said biometric feature detected is considered to be a candidate biometric datum, and it is compared with one or more reference biometric data in the database of the data storage means 12.

All that needs to be done is then to check that this candidate biometric datum matches the/one reference biometric datum. In a known manner, the candidate biometric datum and the reference biometric datum match if their distance according to a given comparison function is less than a predetermined threshold.

Thus, the implementation of the comparison typically comprises the calculation of a distance between the data, the definition of which varies based on the nature of the biometric data considered. The calculation of the distance comprises the calculation of a polynomial between the components of the biometric data, and advantageously, the calculation of a scaler product.

For example, in a case where the biometric data have been obtained from images of an iris, a conventional distance used for comparing two data is the Hamming distance. In the case where the biometric data have been obtained from images of the face of individuals, it is common to use the Euclidean distance.

This type of comparison is known to the person skilled in the art and will not be described in more detail hereinafter.

The individual is authenticated/identified if the comparison reveals a rate of similarity between the candidate datum and the/one reference datum exceeding a certain threshold, the definition of which depends on the calculated distance.

It should be noted that if there are several radiation images, biometric features may be detected on each radiation image (limited to a second region of interest), and thus step (e) may involve each biometric feature detected.

Terminal

According to a second aspect, the present invention relates to the terminal 1 for the implementation of the method according to the first aspect.

The terminal 1 comprises data processing means 11, of processor type, advantageously first optical acquisition means 13a (for the acquisition of a radiation image) and/or second optical acquisition means 13b (for the acquisition of a depth map), and where applicable data storage means 12 storing a reference biometric database.

The data processing means 11 are configured to implement:
obtaining a radiation image and a depth map on each of which appears a biometric feature of said individual;
the identification in said depth map of a first region of interest likely to contain said biometric feature;
the selection in said radiation image of a second region of interest corresponding to said first region of interest identified in the depth map;
the detection of said biometric feature of the individual in said second region of interest selected of said radiation image;
the authentication or identification of said individual on the basis of the biometric feature detected

According to a third and a fourth aspects, the invention relates to a computer program product comprising code instructions for execution (in particular on the data processing means 11 of the terminal 1) of a method according to the first aspect of the invention for authentication or identification of an individual, as well as storage means readable by computer equipment (a memory 12 of the terminal 2) on which this computer program product is located.

1. A method for authentication or identification of an individual, wherein the method comprises the implementation by data processing means of a terminal of the following steps:
(a) obtaining a radiation image and a depth map on each of which appears a biometric feature of said individual;
(b) identifying in said depth map of a first region of interest likely to contain said biometric feature, as all of the pixels of said depth map associated with a depth value which is within a predetermined range;
(c) selecting in said radiation image of a second region of interest corresponding to said first region of interest identified in the depth map;
(d) detecting of said biometric feature of the individual in said second region of interest selected of said radiation image; and,
(e) authenticating or identifying of said individual on the basis of the biometric feature detected.

2. The method according to claim 1, wherein the step (a) comprises the acquisition of said radiation image from data acquired by first optical acquisition means of the terminal and/or the acquisition of said depth map from data acquired by second optical acquisition means of the terminal.

3. The method according to claim 1, wherein said step (c) further comprises the removal from said radiation image of stationary objects.

4. The method according to claim 1, wherein said step (d) further comprises the adaptation of the exposure of the radiation image in relation to the second region of interest selected.

5. The method according to claim 1, wherein the radiation image and the depth map have substantially the same viewpoint.

6. The method according to claim 1, wherein said biometric feature of the individual is selected from a face and an iris of the individual.

7. The method according to claim 1, wherein the step (e) comprises the comparison of the biometric feature detected with reference biometric data stored on data storage means.

8. The method according to claim 1, wherein the step (e) comprises the implementation of an access control based on the result of said biometric identification or authentication.

9. The method according to claim 1, wherein the radiation image is a visible image or an infrared image.

10. A terminal comprising data processing means configured to implement:
the obtaining of a radiation image and of a depth map on each of which appears a biometric feature of an individual;
the identification in said depth map of a first region of interest likely to contain said biometric feature as all of the pixels of said depth map associated with a depth value which is within a predetermined range;
the selection in said radiation image of a second region of interest corresponding to said first region of interest identified in the depth map;
the detection of said biometric feature of the individual in said second region of interest selected of said radiation image;
the authentication or identification of said individual on the basis of the biometric feature detected.

11. The terminal according to claim 10, comprising first optical acquisition means for the acquisition of said radiation image and/or second optical acquisition means for the acquisition of said depth map.

12. A computer program product comprising code instructions for the execution of a method according to claim 1 for authentication or identification of an individual, when said program is executed on a computer.

13. A storage means readable by computer equipment on which a computer program product comprises code instructions for the execution of a method according to claim 1 for authentication or identification of an individual.
